(19) United States
(12) Patent Application Publication
(10) Pub. No.: US 2009/0109011 A1
(43) Pub. Date: Apr. 30, 2009

(54) HEAD-UP DISPLAY SYSTEM EMBEDDED IN VEHICLE

(75) Inventor: PI-SHUANG LEE KUO, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: E-INNOTECH CO., LTD., TAIPEI COUNTY (TW)

(21) Appl. No.: 12/047,630

(22) Filed: Mar. 13, 2008

(30) Foreign Application Priority Data
Oct. 30, 2007 (TW) 096218186

(51) Int. Cl. B60Q 1/00; B60C 23/02

(52) U.S. Cl. 340/441; 73/146.5; 340/449; 345/7

(57) ABSTRACT

A head-up display system embedded in a vehicle having at least one tire is provided. The head-up display system includes a tire sensor, a speed detecting module, a host apparatus and a head-up display apparatus. The tire sensor is disposed within the tire for detecting a temperature and a pressure of the tire, and the speed detecting module detects a speed of the vehicle. The host apparatus drives the tire sensor with a wireless low-frequency signal and receives a high-frequency temperature signal and a high-frequency pressure signal transmitted from the tire sensor. Afterwards, according to the received signals, a processing unit of the host apparatus drives the head-up display apparatus to produce a temperature image, a pressure image and a speed image on a windshield by projecting.

### BACKGROUND OF THE INVENTION

1. Field of the Invention

The present invention is related to a head-up display system, and more particular to a head-up display system that is embedded in a vehicle for displaying the information, such as vehicle speed, tire temperature, tire pressure, and etc.

2. Description of Related Art

Overheated tires are unwanted during driving. But in general, drivers hardly monitor tire temperature of their transport tools, such as vehicles, motorcycles, and etc., directly. Besides taking a break on a drive that lasts several hours for cooling down tire temperature, filling tires with nitrogen is another way to decrease thermal expansion.

In addition, transport tools, such as vehicles and motorcycles, are at high prices and might attract theft. In order to avoid illegal pilfering, various locks are designed for locking the key positions of a vehicle, such as doors, gear stick, steering wheel, ignition switch, and etc.

Taiwanese patents M317357, M315168, M313237, I239908 and 149143 disclose several ways to display tire temperatures and pressures on a display panel respectively. However, during driving with high speed, even though the tire pressures are shown on the dashboard for monitoring as the prior art taught, the driver often focuses his eyes on the complicated real-time traffic rather than on the information shown on the Dashboard except the speedometer gauge. Thus, in practical case, such a way of showing safety information is ineffective.

In recent years, some high-class vehicles are equipped with head-up displays to create a speed image beam in accordance with a detected speed signal and project the speed image beam onto the windshield so as to produce a speed image to inform the driver about information of vehicle speed. The head-up display provides the information about speed image with a much better view angle than the speedometer gauge distributed in the dashboard so as to make the driver conscious of the vehicle speed immediately for ensuring driving safety.

Therefore, the invention provides a head-up display system embedded in a vehicle to improve the problems set above.

### SUMMARY OF THE INVENTION

Accordingly, the objective of the present invention is to provide a head-up display system embedded in a vehicle that displays the information about vehicle speed, tire temperatures and tire pressures with a driver's optimum view angle, and reduces the product cost by integrating a burglarproof function into the host apparatus at the same time.

The present invention provides a head-up display system embedded in a vehicle having at least one tire. The head-up display system includes a tire sensor, a speed detecting module, a host apparatus and a head-up display apparatus.

The tire sensor is disposed within the tire for detecting a temperature and a pressure of the tire to generate a thermo signal and a pressure signal correspondingly. The tire sensor then converts the thermo signal and the pressure signal into a high-frequency thermo signal and a high-frequency pressure signal and transmits the high-frequency thermo signal and the high-frequency pressure signal wirelessly. The speed detecting module detects a speed of the vehicle to generate a speed signal.

The host apparatus includes a low-frequency receiving module, a high-frequency module and a processing unit.

The low-frequency module is activated by the processing unit so as to transmit a wireless low-frequency signal to the tire sensor for driving the tire sensor to generate the thermo signal and the pressure signal.

The high-frequency module receives the wireless high-frequency thermo signal and the wireless high-frequency pressure signal transmitted from the tire sensor. The high-frequency module further converts the wireless high-frequency thermo signal and the wireless high-frequency pressure signal back into the thermo signal and the pressure signal.

The processing unit receives the thermo signal and the pressure signal generated by the high-frequency module and the speed signal generated by the speed detecting module.

The head-up display apparatus receives the thermo signal, the pressure signal and the speed signal from the processing unit, generates a temperature image beam, a pressure image beam and a speed image beam correspondingly, and further optically projects the temperature image beam, the pressure image beam and the speed image beam onto a windshield of the vehicle for producing a temperature image, a pressure image and a speed image to inform a driver.

Moreover, the head-up display system is associated with a portable device correspondingly for unlocking a vehicle lock. The low-frequency transmitting module transmits a wireless low-frequency signal to the portable device for driving the portable device to generate an unlock signal. The unlock signal is further converted into a high-frequency unlock signal and transmitted wirelessly by the portable device.

Therefore, the head-up display system embedded in a vehicle of the present invention could improve the driving safety by showing the information about the vehicle speed, the tire temperature and the tire pressure with the driver's optimum view angle by the head-up display apparatus and the host apparatus. Moreover, the present invention could reduce the product cost by integrating a burglarproof function into the host apparatus at the same time.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

The present invention can be fully understood from the following detailed description and preferred embodiment with reference to the accompanying drawings, in which:

FIG. 1 is an illustrative view showing a head-up display system embedded in a vehicle according to the present invention;

FIG. 2 is a block diagram of a head-up display system according to the present invention;

FIG. 3 is a block diagram of a portable device according to the present invention;

FIG. 4 is a block diagram of a tire sensor according to the present invention; and

FIG. 5 is a block diagram of a head-up display apparatus according to the present invention.

### DETAILED DESCRIPTION OF THE PREFERRED EMBODIMENTS

The objective of the present invention will no doubt become obvious to those of ordinary skill in the art after reading the following detailed description of the preferred embodiment, which is illustrated in the various figures and drawings.

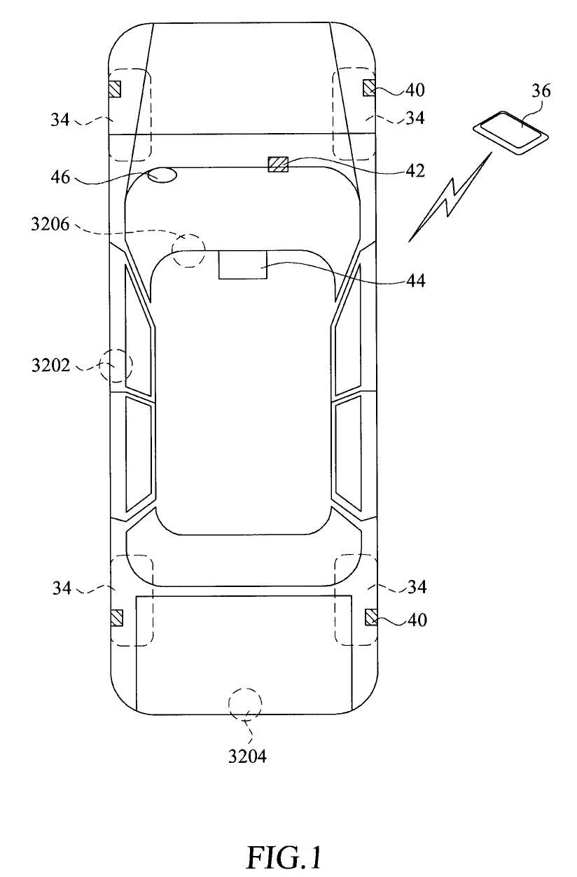

Please refer to FIG. 1 which is an illustrative view showing a head-up display 30 embedded in a vehicle 30 according to the present invention. The present invention provides a head-up display system 30 embedded in a vehicle 32 which includes at least one tire 34. The drawings take the vehicle 32 with four tires 32 as an illustrative example. The head-up display system 30 is associated with a portable device 36 correspondingly for unlocking a vehicle lock. The portable device 36 could be implemented as a card. In addition, the vehicle lock of the vehicle 32 could be one or more locks selected from the group consisting of a door lock 3202, a trunk lock 3204 and an ignition switch lock 3206.

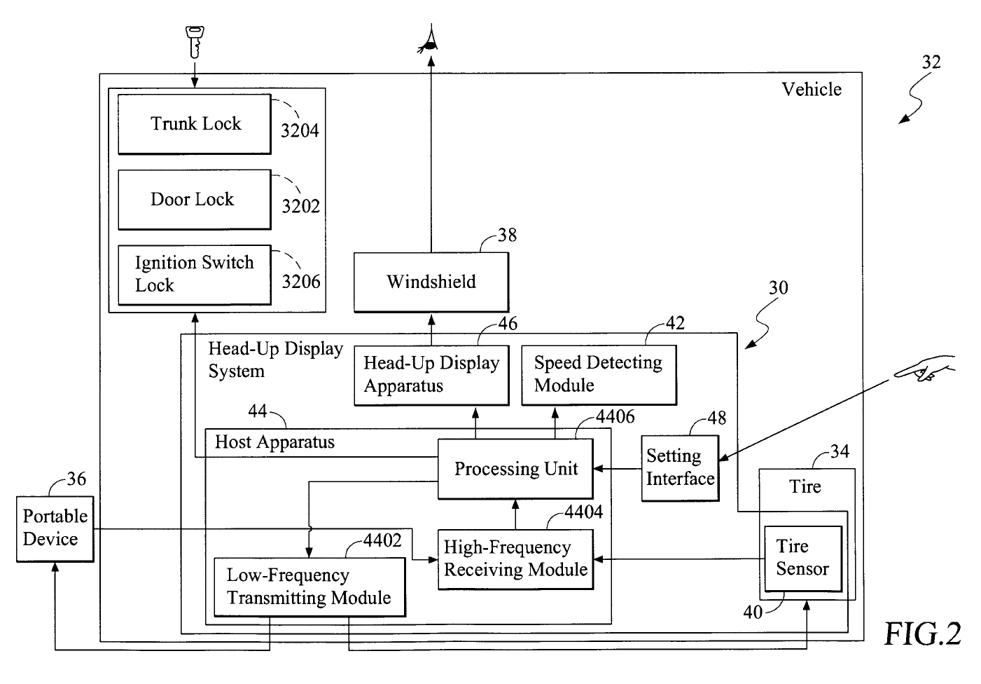

Next, please refer to FIG. 2 which is a block diagram of the head-up display system 30 according to the present invention. The head-up display system 30 embedded in the vehicle 32 includes a tire sensor 40, a speed detecting module 42, a host apparatus 44 and a head-up display apparatus 46.

The tire sensor 40 is disposed within the tire 34 for detecting a temperature and a pressure of the tire 34 so as to generates a thermo signal and a pressure signal correspondingly. Afterwards, the tire sensor 40 converts the thermo signal and the pressure signal into a high-frequency thermo signal and a high-frequency pressure signal, and transmits these two high-frequency signals wirelessly. The speed detecting module 42 detects a speed of the vehicle 32 so as to generate a speed signal.

The host apparatus 44 includes a low-frequency transmitting module 4402, a high-frequency receiving module 4404 and a processing unit 4406.

The low-frequency transmitting module 4402 is activated by the processing unit 4406 so as to transmit a wireless low-frequency signal to the tire sensor 40 and the portable device 36 via an antenna (not shown in the drawings) for driving the tire sensor 40 to generate the thermo signal and the pressure signal and driving the portable device 36 to generate an unlock signal. Afterwards, the portable device 36 converts the unlock signal into a high-frequency unlock signal and transmits the high-frequency unlock signal wirelessly.

The high-frequency receiving module 4404 receives the high-frequency thermo signal and the high-frequency pressure signal generated respectively according to the thermo signal and the pressure signal by the tire sensor 40 via a high-frequency band antenna (not shown in the drawings). Afterwards, the high-frequency receiving module 4404 converts the received high-frequency thermo signal and the high-frequency pressure signal back into the thermo signal and the pressure signal. The high-frequency receiving module 4404 also receives the high-frequency unlock signal generated according to the unlock signal by the portable device 36 via the high-frequency band antenna and converts the received high-frequency unlock signal back into the unlock signal.

The processing unit 4406 receives the thermo signal and the pressure signal from the high-frequency receiving module 4404 and the speed signal from the speed detecting module 42. Meanwhile, the processing unit 4406 also unlocks the vehicle lock in accordance with the unlock signal from the high-frequency receiving module 4404.

The head-up display apparatus 46 receives the thermo signal, the pressure signal and the speed signal from the processing unit 4406 and generates a temperature image beam, a pressure image beam and a speed image beam correspondingly. The head-up display apparatus 46 further projects the temperature image beam, the pressure image beam and the speed image beam onto a windshield 38 of the vehicle 32 for producing a temperature image, a pressure image and a speed image to inform a driver.

Moreover, the head-up system 30 further includes a setting interface 48. The setting interface 48 is capable of generating a setting command in response to an external operation, such as actuation of a function key. The processing unit 4406 creates a safety range and stores the safety range in a storage unit (not shown in the drawings) in accordance with the setting command. Once a value of the thermo signal is out of the safety range, the processing unit 4406 would generate an alarm signal. Meanwhile, the processing unit 4406 controls the head-up display apparatus 46 to make the temperature image beam to flicker. Thus, the temperature image would also flicker at the same time.

Two additional safety ranges according to the speed signal and the pressure signal could also be set by the setting interface 48 following the illustration set above. For example of driving on a freeway, the safety range according to the vehicle speed could be set as 50˜100 km/hr, the safety range according to the tire temperature could be set below 70° C., and the safety range according to the tire pressure could be set as 25˜35 psi.

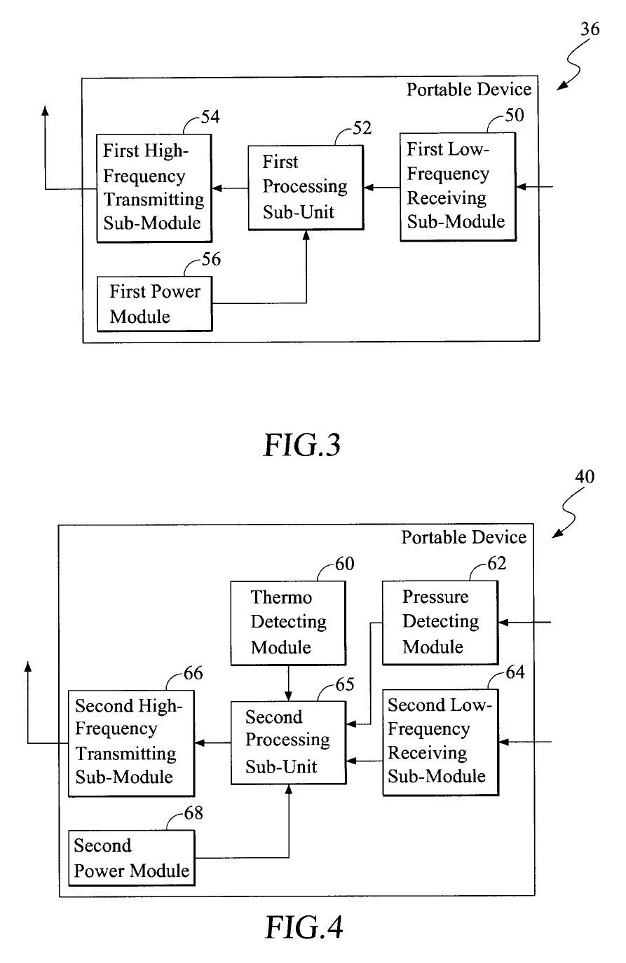

Please refer to FIG. 3 which is a block diagram of the portable device 36 according to the present invention. The wireless low-frequency signal transmitted from the low-frequency transmitting module 4402 of the head-up display apparatus 30 is installed with a coding data. The portable device 36 includes a first low-frequency receiving sub-module 50, a first processing sub-unit 52, a first high-frequency transmitting sub-module 54 and a first power module 56.

The first low-frequency receiving module 50 receives the wireless low-frequency signal transmitted from the low-frequency transmitting module 4402 by a low-frequency band antenna (not shown in the drawings).

The first processing sub-unit 52 is activated in accordance with the wireless low-frequency signal received by the first low-frequency receiving sub-module 50. Afterwards, the first processing sub-unit 52 compares the coding data of the wireless low-frequency signal with a verification data stored in a read-only memory of the portable device 36 in advance. The read-only memory could be a stand-alone device or be integrated in the first processing sub-unit 52. The read-only memory is well-known and will not be illustrated in detail by a drawing herein. When the coding data and the verification are identical, the first processing sub-unit 52 would generate the unlock signal.

The first high-frequency transmitting sub-module 54 converts the unlock signal generated by the first processing sub-unit 52 into the high-frequency unlock signal and transmits the high-frequency unlock signal wirelessly via a high-frequency band antenna (not shown in the drawings). The high-frequency unlock signal could be received by the high-frequency receiving module 4404. The first power module 56 is capable of supplying electrical power to the first processing sub-unit 52.

Please refer to FIG. 4 which is a block diagram of the tire sensor 40 according to the present invention. The tire sensor 40 of the head-up display system 30 includes a thermo detecting module 60, a pressure detecting module 62, a second low-frequency receiving module 64, a second processing sub-unit 65, a second high-frequency transmitting sub-module 66 and a second power module 68.

The thermo detecting module 60 detects the temperature inside the tire so as to generate the thermo signal. The pressure detecting module 62 detects the pressure inside the tire 34 so as to generate a pressure signal.

The second low-frequency receiving module 64 receives the wireless low-frequency signal from the low-frequency transmitting module 4402 via a low-frequency band antenna (not shown in the drawing).

The second processing sub-unit 65 is activated in accordance with the wireless low-frequency signal received by the second low-frequency receiving module 64. Meanwhile, the second processing sub-unit 65 receives the thermo signal and the pressure signal generated by the thermo detecting module 60 and the pressure detecting module 62.

The second high-frequency transmitting sub-module 66 converts the thermo signal and the pressure signal from the second processing sub-unit 65 into the high-frequency thermo signal and the high-frequency pressure signal and further transmits these two high-frequency signals via a high-frequency band (not shown in the drawings). The high-frequency thermo signal and the high-frequency pressure signal could be received by the high-frequency receiving module 4404. The second power module 68 is capable of supplying electrical power to the second processing sub-unit 65.

The pressure detecting module 62 could be implemented mechanically. For example, U.S. Pat. No. 6,525,655 discloses a diaphragm-type tire pressure indicator capable of detecting the tire pressure mechanically. The pressure detecting module 62 could be implemented electrically. For example, U.S. Pat. No. 5,694,111 discloses a tire pressure indicator capable of detecting the tire pressure electrically. The prior art mentioned above is well-known and will not be illustrated in detail herein.

It is noted that besides transmitting wireless low-frequency signal to drive the tire sensor 4402 to generate the thermo signal and the pressure signal by the host apparatus 44 sequentially or un-sequentially, the tire sensor 40 could directly generate and transmit the thermo temperature and the pressure temperature without external driving. The safety ranges respectively according to the tire temperature and the tire pressure are stored in a storage unit (not shown in the drawings) of the tire sensor 40 in advance. The tire sensor 40 keep on working continuously. Once, according to the detection of the thermo detecting module and the pressure detecting module, the temperature or the pressure inside the tire 34 is out of the safety ranges according to the tire temperature and the tire pressure, it represents that either an irregular temperature or an irregular pressure occurs inside the tire 34. At this time, the second processing sub-unit 62 of the tire sensor 40 would generate the temperature signal and the pressure signal directly and transmit these two signals by the second high-frequency transmitting module 66.

No matter driving by the wireless low-frequency signal sequentially or un-sequentially or monitoring irregular factors continuously, if the host apparatus 44 does not receive the thermo signal or the pressure signal for a long time, the host apparatus 44 would regard the tire sensor 40 as failed or out of power and inform the user to change the tire sensor 40.

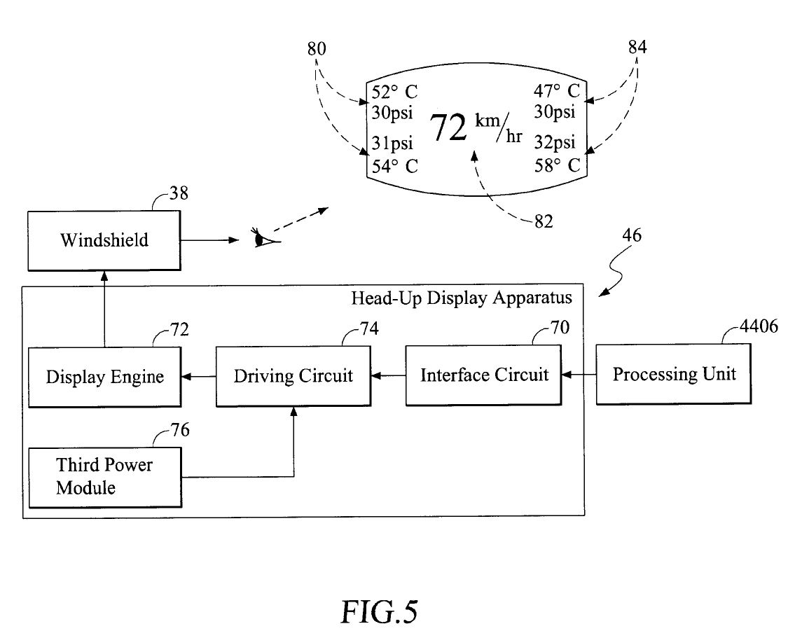

Please refer to FIG. 5 which is a block diagram of the head-up display apparatus 46 according to the present invention. The head-up display apparatus 46 of the head-up display system 30 includes an interface circuit 70, a display engine 72, a driving circuit 74 and a third power module 76.

The interface circuit 70 receives the thermo signal, the speed signal and the pressure signal from the processing unit 4406. The display engine 72 would project an image beam onto the windshield 38 disposed on the transmission path of the image beam. Thus, an image would be produced on the windshield 38.

The driving circuit 74 drives the display engine 72 to generate the temperature image beam, the pressure image beam and the speed image beam in accordance with the received thermo signal, the pressure signal and the speed signal. The temperature image beam, the pressure image beam and the speed image beam would be projected onto the windshield 38 so as to produce the temperature image 80, the pressure image 84 and the speed image 82 to inform the driver.

The third power module 76 is capable of supplying electrical power to the driving circuit 74. The third power module 76 could be a battery of the vehicle 32 and the electrical power stored in the battery is transmitted to the head-up display apparatus directly.

Therefore, through the embodiment illustrated above, one should realize that head-up display system 30 embedded in the vehicle 32 could show the information about the speed of the vehicle 32, the pressure and temperature of the tire 34 with the driver's optimum view angle by the head-up display apparatus 46 and the host apparatus 44 so that the driving safety would be improved substantially. Furthermore, the host apparatus 44 is also integrated with a burglarproof function so that the product cost would be reduced substantially.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A head-up display system, embedded in a vehicle having at least one tire, comprising:
a tire sensor, disposed within the tire for detecting a temperature of the tire to generate a thermo signal, converting the thermo signal into a high-frequency thermo signal, and transmitting the high-frequency thermo signal wirelessly;
a speed detecting module, detecting a speed of the vehicle to generate a speed signal;
a host apparatus, comprising:
a high-frequency receiving module, receiving the high-frequency thermo signal transmitted from the tire sensor, and converting the high-frequency thermo signal back into the thermo signal; and
a processing unit, receiving the thermo signal from the high-frequency receiving module, and the speed signal from the speed detecting module; and
a head-up display apparatus, receiving the thermo signal and the speed signal, generating a temperature image beam and a speed image beam respectively according to the thermo signal and the pressure signal, and further optically projecting the temperature image beam and the speed image beam onto a windshield of the vehicle for producing a temperature image and a speed image.

2. The head-up display system according to claim 1, wherein the host apparatus further comprises a low-frequency transmitting module for transmitting a wireless low-frequency signal to the tire sensor for driving the tire sensor to generate the thermo signal.

3. The head-up display system according to claim 2, wherein the head-up display system is associated with a portable device correspondingly for unlocking a vehicle lock of the vehicle.

4. The head-up display system according to claim 3, wherein the vehicle lock is a door lock.

5. The head-up display system according to claim 3, wherein the vehicle lock is a trunk lock.

6. The head-up display system according to claim 3, wherein the vehicle lock is an ignition switch lock.

7. The head-up display system according to claim 3, wherein the portable device is driven to generate an unlock signal by the wireless low-frequency signal transmitted from the low-frequency transmitting module, converts the unlock signal into a high-frequency unlock signal, and further wirelessly transmits the high-frequency unlock signal which is received and converted back into the unlock signal by the high-frequency receiving module for activating the processing module to unlock the vehicle lock.

8. The head-up display system according to claim 7, wherein the low-frequency transmitting module is driven by the processing unit to transmit the wireless low-frequency signal to the portable device and the tire sensor.

9. The head-up display system according to claim 7, wherein the wireless low-frequency signal transmitted from the low-frequency module is installed with a coding data, and the portable device comprises:
a first low-frequency receiving sub-module, receiving the wireless low-frequency signal transmitted from the low-frequency transmitting module;
a first processing sub-unit, activated by the wireless low-frequency signal received by the first low-frequency receiving sub-module so as to compare the coding data of the wireless low-frequency signal with a verification data and when the coding data and the verification are identical, generate the unlock signal;
a first high-frequency transmitting sub-module, converting the unlock signal generated by the first processing sub-unit into the high-frequency unlock signal, and further transmitting the high-frequency unlock signal wirelessly; and
a first power module, supplying an electrical power to the first processing sub-unit.

10. The head-up display system according to claim 2, wherein the tire sensor comprises:
a thermo detecting module, detecting the temperature inside the tire so as to generate the thermo signal;
a second low-frequency receiving sub-module, receiving the wireless low-frequency signal transmitted from the low-frequency transmitting module;
a second processing sub-unit, activated by the wireless low-frequency signal received by the second low-frequency receiving sub-module so as to receive the thermo signal generated by the thermo detecting module;
a second high-frequency transmitting sub-module, converting the thermo signal into the high-frequency thermo signal, and further transmitting the high-frequency thermo signal wirelessly; and
a second power module, supplying an electrical power to the second processing sub-unit.

11. The head-up display system according to claim 10, wherein the tire sensor further comprises a pressure detecting module for detecting a pressure of the tire so as to generate a pressure signal, converting the pressure signal into a high-frequency pressure signal, and transmitting the high-frequency pressure signal wirelessly, which the high-frequency pressure signal is received and converted backed into the pressure signal by the high-frequency receiving module.

12. The head-up display system according to claim 11, wherein the processing unit receives the pressure signal from the high-frequency receiving module, and controls the head-up display apparatus to generate a pressure image beam and project the pressure image beam onto the windshield for producing a pressure image.

13. The head-up display system according to claim 1, wherein the head-up display apparatus comprises:
a display engine;
an interface circuit, receiving the thermo signal and the speed signal from the processing unit;
a driving circuit, driving the display engine to generate the temperature image beam and the speed image beam in accordance with the thermo signal and the speed signal received by the interface circuit; and
a third power module, supplying an electrical power to the driving circuit;
wherein the temperature image beam and the speed image beam are projected onto the windshield so as to produce the temperature image and the speed image.

14. The head-up display system according to claim 1, further comprising a setting interface capable of generating a setting command in response to an external operation, wherein the processing unit generates a safety range according to the setting command, and when a value of the thermo signal is out of the safety range, the processing unit generates an alarm signal to make the temperature image to flicker by making the temperature image beam to flicker.

15. The head-up display system according to claim 1, wherein a safety range according to the temperature is stored in the tire sensor in advance, and when a value of the thermo signal is out of the safety range, the tire sensor generates the thermo signal.

16. The head-up display system according to claim 15, wherein an additional safety range according to the pressure is stored in the tire sensor in advance, and when a value of the pressure signal is out of the additional safety range, the tire sensor generates a pressure signal.
